(19) United States
(12) Patent Application Publication
(10) Pub. No.: US 2026/0132674 A1
(43) Pub. Date: May 14, 2026

(54) Hydrophobic Cellular Compatible Coating

(71) Applicant: Vitro Flat Glass LLC, Cheswick, PA (US)

(72) Inventor: James W. McCamy, Export, PA (US)

(21) Appl. No.: 19/386,293

(22) Filed: Nov. 12, 2025

Related U.S. Application Data
(60) Provisional application No. 63/720,204, filed on Nov. 14, 2024.

(51) Int. Cl. E06B 9/24; C03C 17/09; C03C 17/245; C03C 17/32; C09D 1/00; C09D 5/16; C09D 5/24; E06B 3/67

(52) U.S. Cl. CPC E06B 9/24; C03C 17/09; C03C 17/245; C03C 17/328; C09D 1/00; C09D 5/16; C09D 5/24; E06B 3/6715; C03C 2217/76; C03C 2218/156; C03C 2218/328; E06B 2009/2417

(57) ABSTRACT

An article includes a glass substrate having a No. 1 surface and a No. 2 surface opposite the No. 1 surface, a hydrophobic coating over at least a portion of the No. 1 surface, and a patterned conductive coating over at least a portion of the No. 2 surface. Also provided is an article including a first glass substrate having a No. 1 surface and a No. 2 surface opposite the No. 1 surface, a second glass substrate opposite the first glass substrate having a No. 3 surface and a No. 4 surface opposite the No. 3 surface, a hydrophobic coating over at least a portion of the No. 1 surface, and a patterned conductive coating over at least a portion of the No. 2 surface or the No. 3 surface.

### CROSS-REFERENCE TO RELATED APPLICATIONS

This application claims priority to U.S. Provisional Application No. 63/720,204, filed Nov. 14, 2024, the disclosure of which is incorporated by reference in its entirety.

### BACKGROUND OF THE INVENTION

### Field of the Invention

The present application relates generally to transparent coated articles and, more specifically, to glass articles having a hydrophobic coating and a patterned conductive coating.

### Technical Considerations

Many glass structures, such as automotive glass structures and architectural glass structures, include coatings that block radiation in the ultraviolet (UV) and infrared (IR) wavelengths to reduce heat within the spaces housed by the glass structures. Drawbacks to these coatings include reduction in cellular compatibility, as many signals in the 5G range, for example, are disrupted by the presence of materials blocking ultraviolet and infrared radiation. Further, 5G signals may be compromised in the presence of water, as water may absorb electromagnetic field transmissions in the gigahertz (GHz) range.

Accordingly, those skilled in the art continue research and development in the field of glass articles, and more particularly, to automotive glass articles and architectural glass articles having cellular compatibility.

### SUMMARY OF THE INVENTION

Disclosed are articles.

In one example, the article includes a glass substrate having a No. 1 surface and a No. 2 surface opposite the No. 1 surface, a hydrophobic coating over at least a portion of the No. 1 surface, and a patterned conductive coating over at least a portion of the No. 2 surface.

The hydrophobic coating may be applied to the No. 1 surface using a Magnetron Sputter Vapor Deposition (MSVD) coating process. The hydrophobic coating may include one or more metal oxides. The hydrophobic coating may include titanium, hafnium, silicon, aluminum, or cerium. The hydrophobic coating may include a fluorinated organic material.

The patterned conductive coating may have a thickness of 2 nm to 200 nm. The patterned conductive coating may include silver. The patterned conductive coating may have a dielectric layer and a reflective layer.

The article may be an architectural structure or a window.

In another example, the article includes a first glass substrate having a No. 1 surface and a No. 2 surface opposite the No. 1 surface, a second glass substrate opposite the first glass substrate having a No. 3 surface and a No. 4 surface opposite the No. 3 surface, a hydrophobic coating over at least a portion of the No. 1 surface, a patterned conductive coating over at least a portion of the No. 2 surface or the No. 3 surface.

The hydrophobic coating may be applied to the No. 1 surfacing using a MSVD coating process. The hydrophobic coating may include one or more metal oxides. The hydrophobic coating may include titanium, hafnium, silicon, aluminum, or cerium. The hydrophobic coating may include a fluorinated organic material.

The patterned conductive coating may have a dielectric layer and a reflective layer. The patterned coating may include silver. The patterned conductive coating may have a thickness of 2 nm to 200 nm.

The hydrophobic coating may be applied to the No. 1 surface using a Chemical Vapor Deposition (CVD) coating process. The hydrophobic coating may include one or more metal oxides. The hydrophobic coating may include titanium, hafnium, silicon, aluminum, or cerium.

The patterned conductive coating may have a thickness of 2 nm to 200 nm. The patterned conductive coating may have silver. The patterned conductive coating may have a dielectric layer and a reflective layer.

The article may be an architectural structure or a window.

Other examples will become apparent from the following detailed description, the accompanying drawings, and the appended claims.

### BRIEF DESCRIPTION OF THE DRAWINGS

The disclosure will be described with reference to the following drawing figures wherein like reference numbers identify like parts throughout.

FIG. 1 is a cross-sectional schematic (not to scale) of a non-limiting article according to the invention;

FIG. 2 is a cross-sectional schematic (not to scale) of a non-limiting article according to the invention;

FIG. 3 is a cross-sectional schematic (not to scale) of a non-limiting article according to the invention;

FIG. 4 is a cross-sectional view (not to scale) of a single metal patterned conductive coating according to an example of the invention.

FIG. 5 is a cross-sectional view (not to scale) of a double metal patterned conductive coating according to an example of the invention.

FIG. 6 is a cross-sectional view (not to scale) of a triple metal patterned conductive coating according to an example of the invention.

FIG. 7 is a cross-sectional view (not to scale) of a quadruple metal patterned conductive coating according to an example of the invention.

FIGS. 8A and 8B are side views (not to scale) of exemplary insulating glass units (“IGU”) according to an example of the invention.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like.

“A” or “an” refers to one or more.

Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate.

As used herein, the terms “polymer” or “polymeric” include oligomers, homopolymers, copolymers, and terpolymers, e.g., polymers formed from two or more types of monomers or polymers.

The terms “visible region” or “visible light” refer to electromagnetic radiation having a wavelength in the range of 380 nm to 800 nm. The terms “infrared region” or “infrared radiation” refer to electromagnetic radiation having a wavelength in the range of greater than 800 nm to 100,000 nm. The terms “ultraviolet region” or “ultraviolet radiation” mean electromagnetic energy having a wavelength in the range of 300 nm to less than 380 nm.

Additionally, all documents, such as, but not limited to, issued patents and patent applications, referred to herein are to be considered to be “incorporated by reference” in their entirety.

As used herein, the term “film” refers to a coating region of a desired or selected coating composition. A “layer” can comprise one or more “films”, and a “coating” or “coating stack” can comprise one or more “layers”. The terms “metal” and “metal oxide” include silicon and silica, respectively, as well as traditionally recognized metals and metal oxides, even though silicon conventionally may not be considered a metal. Thickness values, unless indicated to the contrary, are geometric thickness values.

The discussion of the invention may describe certain features as being “particularly” or “preferably” within certain limitations (e.g., “preferably”, “more preferably”, or “most preferably”, within certain limitations). It is to be understood that the invention is not limited to these particular or preferred limitations but encompasses the entire scope of the disclosure.

The present disclosure relates to glass structures having hydrophobic coatings. Water is known to absorb electromagnetic field (EMF) transmissions in the GHz range. Atmospheric moisture and rain commonly degrades cell phone transmissions, particularly in the 5G bands. Water on the surface of the façade glass will also degrade the transmission. Having a hydrophobic coating on the exterior surface helps reduce the amount and time that water (from rain or condensation) will disrupt the transmission and increase the bandwidth of the signal. The present disclosure combines creating a hydrophobic surface, either through surface roughening or through application of a hydrophobic coating, with conductive coatings that are patterned to improve transmission through that coating while blocking radiation that may increase heat inside a building or vehicle.

The invention is directed an article. The article comprises a glass substrate having a No. 1 surface and a No. 2 surface opposite the No. 1 surface, a hydrophobic coating over at least a portion of the No. 1 surface and a patterned conductive coating over at least a portion of the No. 2 surface.

The article 10 may be an automotive component, such as a windshield, a side window, or a rear window. In another example, the article 10 may be an architectural structure, such as a window. In yet another example, the article 10 may be a window in a transportation vehicle such as a train or aerospace component.

In one example, the article 10 includes a glass substrate 12, such as a soda-lime glass, soda-lime-silicate glass, borosilicate glass, or leaded glass. In yet another example, the article 10 comprises a tempered glass substrate 12. The glass substrate 12 of the article 10 has a No. 1 surface 14 and a No. 2 surface 16 opposite the No. 1 surface 14. The glass substrate 12 can be a clear glass substrate. By “clear glass” is meant non-tinted or non-colored glass. Alternatively, the glass substrate 12 can be tinted or otherwise colored glass. The glass substrate 12 can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155.

The glass substrate 12 may comprise clear float glass or can be tinted or colored glass. The glass substrate 12 can be of any desired dimensions, e.g., length, width, shape, or thickness. In one non-limiting embodiment in which the glass substrate 12 is an architectural transparency, the glass substrate 12 may be 1 mm to 30 mm thick, such as 2.5 mm to 25 mm thick, such as 2.5 mm to 10 mm. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparencies such as glasses and the like. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

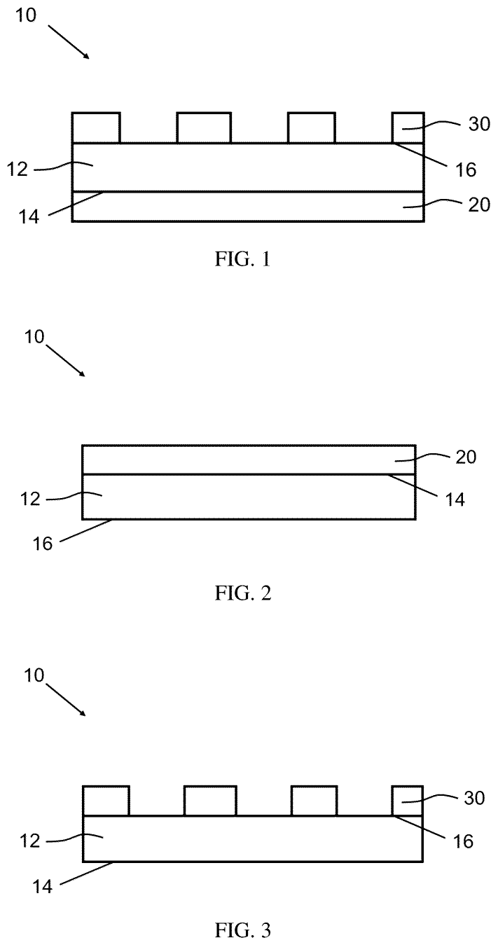

In some embodiments, the glass substrate 12 can be a monolithic glazing, as shown in FIGS. 1-3. By “monolithic” is meant having a single structural support or structural member, e.g., having a single glass substrate.

A hydrophobic coating 20 may be applied over at least a portion of the No. 1 surface 14 of the glass substrate 12 (FIGS. 1 and 2). The hydrophobic coating 20 may be applied to the No. 1 surface 14 of the glass substrate 12 using an MSVD coating process. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750. In another example, the hydrophobic coating 20 may be applied to the No. 1 surface 14 of the glass substrate 12 using a CVD coating process. Examples of CVD processes include spray pyrolysis. In another example, the hydrophobic coating 20 may be applied to the No. 1 surface 14 of the glass substrate 12 using a plasma enhanced CVD coating process. In another example, the hydrophobic coating 20 may be applied to the No. 1 surface 14 of the glass substrate 12 using a sol-gel deposition process.

The hydrophobic coating 20 may be applied on the No. 1 surface 14 of the glass substrate 12 after the glass substrate 12 is tempered. Alternatively, the hydrophobic coating 20 may be applied on the No. 1 surface 14 of the glass substrate 12 before the glass substrate 12 is tempered.

The hydrophobic coating 20 may include any composition having hydrophobic properties.

In one example, the hydrophobic coating 20 may include one or more inorganic materials including, but not limited to one or more metal oxides, one or more ceramic materials, or combinations thereof.

The hydrophobic coating 20 may include titanium, hafnium, silicon, aluminum, or cerium. The titanium, hafnium, silicon, aluminum, or cerium may be deposited onto the No. 1 surface 14 of the glass substrate 12 by a CVD coating process.

The hydrophobic coating 20 may include graphene.

The hydrophobic coating 20 may include a fluorinated organic material. For example, the fluorinated organic material may be ethylene tetrafluoroethylene (ETFE). To form the hydrophobic coating 20, the ETFE may be applied as a sheet that is positioned over at least a portion of the No. 1 surface 14 of the glass substrate 12. The ETFE sheet may be applied over at least a portion of the No. 1 surface 14 of the glass substrate 12 using an adhesive. Alternatively, the ETFE sheet may be applied over at least a portion of the No. 1 surface 14 of the glass substrate 12 without an adhesive.

Alternatively, the No. 1 surface 14 of the glass substrate 12 may be modified to be hydrophobic. For example, during the preparation of the glass substrate 12, nanoparticles, such as borosilicate nanoparticles, may be embedded or incorporated into the No. 1 surface 14 of the glass substrate 12. Alternatively, during the preparation of the glass substrate 12, metal nanoparticles and/or metal oxide nanoparticles, may be embedded or incorporated into the No. 1 surface 14 of the glass substrate 12. The metal nanoparticles may comprise hafnium, titanium, silicon, aluminum, cerium, or combinations thereof. The metal oxide nanoparticles may comprise oxides of hafnium, titanium, silicon, aluminum, cerium, or combinations thereof. This process is described in US Patent Application Publication No. 2020/0203665 A1, which is incorporated herein by reference in its entirety. The embedding or incorporation of the nanoparticles or metal into the No. 1 surface 14 of the glass substrate 12 may provide the No. 1 surface 14 with a surface roughness.

The hydrophobic coating 20 over at least a portion of the No. 1 surface 14 of the glass substrate 12 may be the only coating on the glass substrate 12 (FIG. 2).

A patterned conductive coating 30 may be applied over at least a portion of the No. 2 surface 16 of the glass substrate 12 (FIGS. 1 and 3). The patterned conductive coating 30 may have any suitable thickness. In one example, the patterned conductive coating 30 may comprise a total thickness of up to and including 1,000 nanometers (nm). In another example, the patterned conductive coating 30 may comprise a total thickness in range of from about 2 nm to about 1,000 nm, such as from about 2 nm to about 800 nm, such as from about 2 nm to about 600 nm, such as from about 2 nm to about 400 nm, or such as from about 2 nm to about 200 nm. In another example, the patterned conductive coating 30 may comprise a total thickness in a range of from 50 nm to 150 nm or such as from 100 nm to 150 nm.

The patterned conductive coating 30 may include any composition having desired material properties. In one example, the patterned conductive coating 30 comprises silver. In another example, the patterned conductive coating 30 comprises a dielectric layer and a reflective layer. In another example, the patterned conductive coating 30 comprises a transparent conductive oxide.

The patterned conductive coating 30 is an electrically conductive coating that is deposited over at least a portion of the No. 2 surface 16 of the glass substrate 12. The patterned conductive coating 30 may include one, two, three, or four metallic films positioned between dielectric layers applied sequentially over at least a portion of No. 2 surface of 16 of the glass substrate 12. The patterned conductive coating 30 can be a heat and/or radiation reflecting coating and can have one or more coating layers or films of the same or different composition and/or functionality.

Non-limiting examples of suitable patterned conductive coatings 30 typically include one or more antireflective coating films comprising dielectric or anti-reflective materials, such as metal oxides or oxides of metal alloys, which are transparent to visible light. The patterned conductive coating 30 can also include one, two, three, or four metallic layers comprising a reflective metal, e.g., a noble metal such as gold, copper or silver, or combinations or alloys thereof, and can further comprise a primer layer or barrier film, such as titanium, a titanium aluminum alloy, or a zinc aluminum alloy located over and/or optionally under the metal reflective layer. The patterned conductive coating 30 can have at least one metallic layer or may have no more than four metallic layers. For example, the patterned conductive coating 30 consists of one metallic layer. Alternatively, the patterned conductive coating 30 consists of two metallic layers. Alternatively, the patterned conductive coating 30 consists of three metallic layers. Alternatively, the patterned conductive coating 30 consists of four metallic layers. One or more of the metallic layers may comprise silver.

The patterned conductive coatings 30 may include one or more coating films comprising a transparent conductive oxide. The transparent conductive oxide can be a doped metal oxide such as gallium-doped zinc oxide (GZO), aluminum-doped zinc oxide (AZO), indium-doped zinc oxide (IZO) magnesium-doped zinc oxide (MZO), or tin-doped indium oxide (ITO).

The patterned conductive coating 30 may be deposited by any conventional method, such as but not limited to conventional CVD and/or physical vapor deposition (PVD) methods. Examples of CVD processes include spray pyrolysis. Examples of PVD processes include electron beam evaporation and vacuum sputtering (such as MSVD). Other coating methods could also be used, such as but not limited to sol-gel deposition. In one non-limiting embodiment, the patterned conductive coating 30 may be deposited by MSVD.

The patterned conductive coating 30 over at least a portion of the No. 2 surface 16 of the glass substrate 12 may be the only coating on the glass substrate 12 (FIG. 3).

The patterned conductive coating 30 may be a solar control coating. As used herein, the term “solar control coating” refers to a coating comprised of one or more layers or films that affect the solar properties of the coated article, such as, but not limited to, the amount of solar radiation, for example, visible, infrared, or ultraviolet radiation, reflected from, absorbed by, or passing through the coated article; shading coefficient; emissivity, etc. The patterned conductive coating 30 can block, absorb, or filter selected portions of the solar spectrum, such as, but not limited to, the IR, UV, and/or visible spectrums.

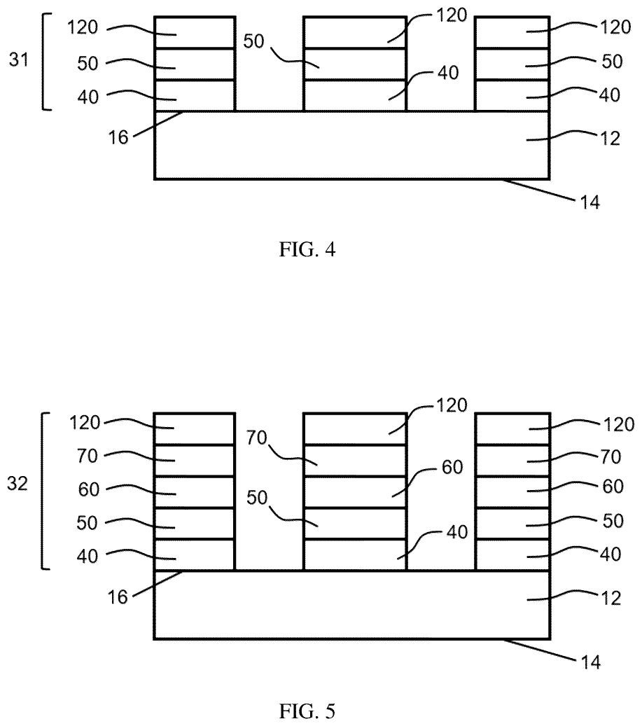

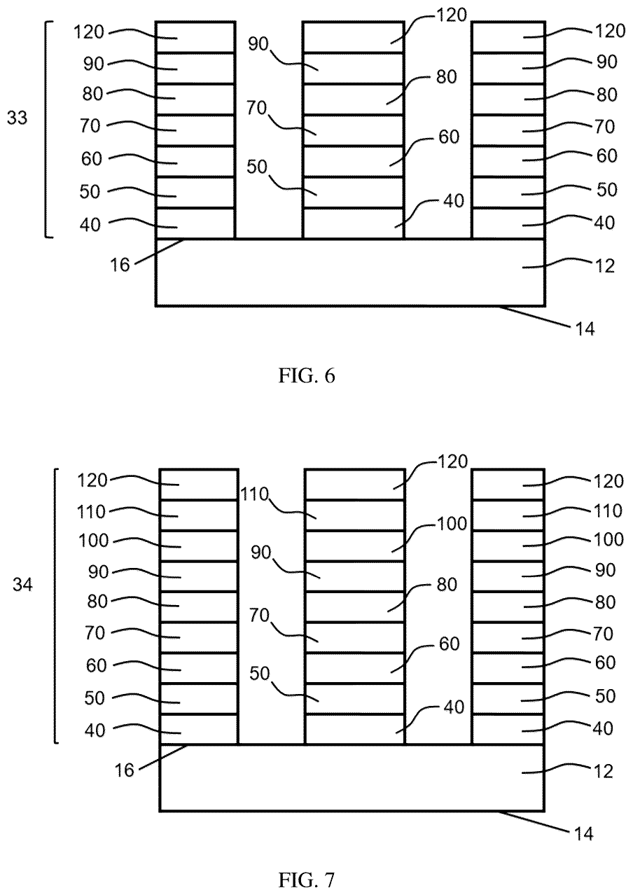

The patterned conductive coating 30 can be a single metal coating 31 (e.g., one metallic layer), or a double metal coating 32 (e.g., two metallic layers), or a triple metal coating 33 (e.g., three metallic layers), or a quadruple metal coating 34 (e.g., four metallic layers). An exemplary non-limiting coating suitable for the single metal coating 31 is shown in FIG. 4. An exemplary non-limiting coating suitable for the double metal coating 32 is shown in FIG. 5. An exemplary non-limiting coating suitable for the triple metal coating 33 is shown in FIG. 6. An exemplary non-limiting coating suitable for the quadruple metal coating 34 is shown in FIG. 7. Although not shown in each of FIGS. 4-7, the hydrophobic coating 20 may be positioned over the No. 1 surface 14 of the glass substrate 12.

The patterned conductive coating 30 includes a pattern. The pattern of the patterned conductive coating 30 may be any pattern known to those of ordinary skill in the art. The presence of the pattern within the patterned conductive coating 30 prevents the conductive coating from being fully conductive (i.e., the presence of the pattern breaks the conductivity of the conductive coating). By preventing the conductive coating 30 from being fully conductive, cellular signals, such as signals in the 5G range, are able to pass through the patterned conductive coating 30.

The size of the pattern is not particularly limited. The space between each pattern may be less than or equal to 50 microns (μm), such as less than or equal to 40 μm, such as less than or equal to 30 μm, such as less than or equal to 20 μm, or such as less than or equal to 10 μm. The space between each pattern may be about 10 μm to about 50 μm, such as about 10 μm to about 40 μm, such as about 10 μm to about 30 μm, such as about 10 μm to about 20 μm, such as about 20 μm to about 50 μm, such as about 20 μm to about 40 μm, such as about 20 μm to about 30 μm, such as about 30 μm to about 50 μm, such as about 30 μm to about 40 μm, or such as about 40 μm to about 50 μm.

The pattern within the conductive coating 30 may be formed using a negative patterning method in which the pattern is formed in the conductive coating after the conductive coating is formed. For example, the pattern within the conductive coating may be formed using laser ablation, chemical etching, ion beam, mechanical scribing, or any combination thereof, which removes a portion of the conductive coating 30 from the No. 2 surface 16 of the glass substrate 12.

The pattern within the conductive coating 30 may be formed using a positive patterning method in which the pattern within the conductive coating is formed as the conductive coating is being applied onto the No. 2 surface 16 of the glass substrate 12. For example, the pattern within the conductive coating may be formed using a masking technique. In the masking technique, a mask comprising a plurality of masked regions and a plurality of un-masked regions may be applied over at least a portion of the No. 2 surface of the glass substrate 12 and the conductive coating may be applied through plurality of un-masked regions of the mask and onto the No. 2 surface 16 of the glass substrate 12 to form the patterned conductive coating 30. The mask may comprise a plurality of masked regions and a plurality of un-masked regions arranged in any suitable manner to form the desired pattern.

An exemplary patterned conductive coating 30 includes one metallic layer (i.e., a single metal coating 31), as shown in FIG. 4. The single metal coating 31 may include a base layer 40 positioned over and in direct contact with the No. 2 surface 16 of the glass substrate 12. The base layer 40 may be positioned over and in direct contact with a portion or the entire No. 2 surface 16 of the glass substrate 12. A metallic layer 50 may be positioned over or in direct contact with at least a portion of the base layer 40. An optional first primer layer may be positioned over or in direct contact with at least a portion of the metallic layer 50. A top layer 120 may be positioned over or in direct contact with at least a portion of the optional first primer layer or the metallic layer 50. An optional outermost protective coating may be positioned over or in direct contact with at least a portion of the top layer 120.

An exemplary patterned conductive coating 30 includes two metallic layers (i.e., a double metal coating 32), as shown in FIG. 5. The double metal coating 32 may include a base layer 40 positioned over and in direct contact with the No. 2 surface 16 of the glass substrate 12. The base layer 40 may be positioned over and in direct contact with a portion of or the entire No. 2 surface 16 of the glass substrate 12. A metallic layer 50 may be positioned over or in direct contact with at least a portion of the base layer 40. An optional first primer layer may be positioned over or in direct contact with at least a portion of the metallic layer 50. A second layer 60 may be positioned over at least a portion of the optional first primer layer 52 or the metallic layer 50. A second metallic layer 70 may be positioned over or in direct contact with at least a portion of the second layer 60. An optional second primer layer may be positioned over or in direct contact with at least a portion of the second metallic layer 70. A top layer 120 may be positioned over or in direct contact with at least a portion of the optional second primer layer or the second metallic layer 70. An optional outermost protective coating may be positioned over or in direct contact with at least a portion of the top layer 120.

An exemplary patterned conductive coating 30 includes three metallic layers (i.e., a triple metal coating 33), as shown in FIG. 6. The triple metal coating 33 may include a base layer 40 positioned over and in direct contact with the No. 2 surface 16 of the glass substrate 12. The base layer 40 may be positioned over and in direct contact with a portion of or the entire No. 2 surface 16 of the glass substrate 12. A metallic layer 50 may be positioned over or in direct contact with at least a portion of the base layer 40. An optional first primer layer may be positioned over or in direct contact with at least a portion of the metallic layer 50. A second layer 60 is positioned over at least a portion of the optional first primer layer or the metallic layer 50. A second metallic layer 70 may be positioned over or in direct contact with at least a portion of the second layer 60. An optional second primer layer may be positioned over or in direct contact with at least a portion of the second metallic layer 70. A third layer 80 may be positioned over or in direct contact with at least a portion of the optional second primer layer or the second metallic layer 70. A third metallic layer 90 may be positioned over or in direct contact with at least a portion of the third layer 80. An optional third primer layer may be positioned over or in direct contact with at least a portion of the third metallic layer 90. A top layer 120 may be positioned over or in direct contact with at least a portion of the optional third primer layer or the third metallic layer 90. An optional outermost protective coating may be positioned over or in direct contact with at least a portion of the top layer 120.

An exemplary patterned conductive coating 30 includes four metallic layers (i.e., a quadruple metal coating 34), as shown in FIG. 7. The quadruple metal coating 34 may include a base layer 40 positioned over and in direct contact with the No. 2 surface 16 of the glass substrate 12. The base layer 40 may be positioned over and in direct contact with a portion of or the entire No. 2 surface 16 of the glass substrate 12. A metallic layer 50 may be positioned over or in direct contact with at least a portion of the base layer 40. An optional first primer layer may be positioned over or in direct contact with at least a portion of the metallic layer 50. A second layer 60 may be positioned over at least a portion of the optional first primer layer or the metallic layer 50. A second metallic layer 70 may be positioned over or in direct contact with at least a portion of the second layer 60. An optional second primer layer may be positioned over or in direct contact with at least a portion of the second metallic layer 70. A third layer 80 may be positioned over or in direct contact with at least a portion of the optional second primer layer or the second metallic layer 70. A third metallic layer 90 may be positioned over or in direct contact with at least a portion of the third layer 80. An optional third primer layer may be positioned over or in direct contact with at least a portion of the third metallic layer 90. A fourth layer 100 may be positioned over or in direct contact with at least a portion of the optional third primer layer or third metallic layer 90. A fourth metallic layer 110 may be positioned over or in direct contact with at least a portion of the fourth layer 100. An optional fourth primer layer may be positioned over or in direct contact with at least a portion of the fourth metallic layer 110. A top layer 120 may be positioned over or in direct contact with at least a portion of the optional fourth primer layer or the fourth metallic layer 110. An optional outermost protective coating may be positioned over or in direct contact with at least a portion of the top layer 120.

The base layer 40, the second layer 60, the third layer 80, the fourth layer 100, and the top layer 120 may be dielectric layers. For example, the base layer 40, the second layer 60, the third layer 80, the fourth layer 100, and the top layer 120 may comprise metal or metal alloy oxides, nitrides, oxynitrides, or mixtures thereof. Examples of suitable metal oxides, metal nitrides, and/or metal oxynitrides include oxides, nitrides, and/or oxynitrides of titanium, hafnium, zirconium, niobium, zinc, bismuth, lead, indium, tin, aluminum, silicon and mixtures thereof. The metal oxides can have small amounts of other materials, such as manganese in bismuth oxide, tin in indium oxide, etc. Additionally, oxides or nitrides of metal alloys or metal mixtures can be used, such as oxides containing zinc and tin (e.g., zinc stannate, defined below), oxides of indium-tin alloys, silicon nitrides, silicon aluminum nitrides, or aluminum nitrides. Further, doped metal oxides, such as antimony or indium tin oxides or nickel or boron doped silicon oxides, can be used. Alternatively, the base layer 40, the second layer 60, the third layer 80, the fourth layer 100, and the top layer 120 may comprise a transparent conductive oxide. The transparent conductive oxide can be a doped metal oxide such as GZO, AZO, IZO, MZO, or ITO. For example, the base layer 40, the second layer 60, the third layer 80, the fourth layer 100, and the top layer 120 may comprise one or more films of silicon nitride, silicon oxide, silicon aluminum nitride, silicon aluminum oxide, silicon oxynitride, silicon aluminum oxynitride, zinc oxide, zinc stannate, or tin oxide.

The first metallic layer 50, the second metallic layer 70, the third metallic layer 90, and the fourth metallic layer 110 may each independently be continuous or discontinuous. The first metallic layer 50, the second metallic layer 70, the third metallic layer 90, and the fourth metallic layer 110 may each independently include a reflective metal, such as, but not limited to, metallic gold, copper, palladium, aluminum, silver, or mixtures, alloys, or combinations thereof.

The optional first primer layer, the optional second primer layer, the optional third primer layer, and the optional fourth primer layer, when present, may include an oxygen-capturing material that can be sacrificial during the deposition process to prevent degradation or oxidation of the metallic layers during the sputtering process or subsequent heating processes. Examples of materials useful for the first primer layer, the second primer layer, the third primer layer, and the fourth primer layer include titanium, silicon, silicon dioxide, silicon nitride, silicon oxynitride, nickel, zirconium, aluminum, cobalt, chromium, titanium, aluminum, an alloy thereof, or a mixture thereof. For example, first primer layer, the optional second primer layer, the optional third primer layer, and the optional fourth primer layer may each independently comprise titanium, titanium and aluminum, or zinc and aluminum.

The optional outermost protective coating may be formed over at least a portion of the top layer 120 of the patterned conductive coating 30 and may be the outermost coating of the coated article. The outermost protective coating can help protect the underlying functional coating layers, from mechanical and/or chemical attack. The outermost protective coating can be an oxygen barrier coating layer to prevent or reduce the passage of ambient oxygen into the underlying layers of the coating, such as, during heating or bending. The outermost protective coating can be of any desired material or mixture of materials and can be comprised of one or more protective films. The outermost protective coating may comprise a protective layer, wherein the protective layer comprises at least one of Si₃N₄, SiAlN, SiAlON, SiAlO, TiAlO, titania, alumina, silica, zirconia, or combinations thereof.

Also provided herein is an article comprising: a first glass substrate having a No. 1 surface and a No. 2 surface opposite the No. 1 surface; a second glass substrate opposite the first glass substrate having a No. 3 surface and a No. 4 surface opposite the No. 3 surface; a hydrophobic coating over at least a portion of the No. 1 surface; and a patterned conductive coating over at least a portion of the No. 2 surface or the No. 3 surface.

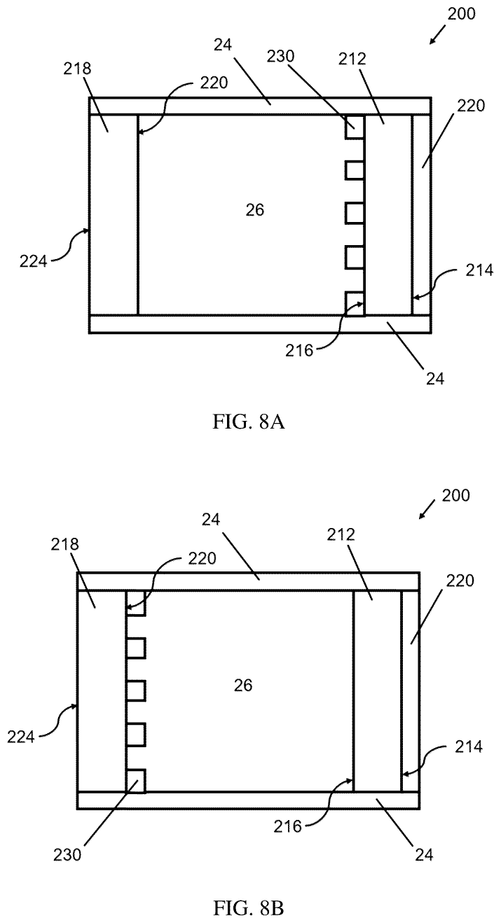

The articles described herein can be used in an architectural transparency or architectural glazing, such as, but not limited to, an insulating glass unit. Non-limiting insulating glass units 200 incorporating the features of the invention are provided in FIGS. 8A-8B. The insulating glass unit 200 includes a first ply 212 comprising a No. 1 surface 214 and No. 2 surface 216, where the No. 2 surface 216 is opposite the No. 1 surface 214. In the illustrated non-limiting embodiment, the first major surface 214 faces the building exterior, i.e., is an outer major surface, and the second major surface 216 faces the interior of the building. The insulated glass unit 200 also includes a second ply 218 comprising a No. 3 surface 220 and a No. 4 surface 222, where the No. 4 surface is opposite the No. 3 surface 220. The second ply 218 is spaced from the first ply 212. In some embodiments, the insulating glass unit 200 includes a third ply with a first side and a second side. The first side of the third ply comprises a first major surface (No. 5 surface) and an opposed second side of the third ply comprises a second major surface (No. 6 surface). This numbering of the ply surfaces is in keeping with conventional practice in the fenestration art. The plies 212, 218 can have any desired visible light, infrared radiation, or ultraviolet radiation transmission and/or reflection. For example, the plies 212, 128 can have a visible light transmission of any desired amount, e.g., greater than 0% up to 100%. The plies 212, 218 can each be, for example, clear float glass or can be tinted or colored glass or one ply 212, 218 can be clear glass and the other ply 212, 218 colored glass. Although not limiting to the invention, examples of glass suitable for the first ply 212 and/or second ply 218 are described in U.S. Pat. Nos. 4,746,347; 4,792,536; 5,030,593; 5,030,594; 5,240,886; 5,385,872; and 5,393,593. Examples of insulating glass units are found, for example, in U.S. Pat. Nos. 4,193,236; 4,464,874; 5,088,258; and 5,106,663.

The first ply 212 and second ply 218 are connected together in any suitable manner, such as, by being adhesively bonded to a conventional spacer frame 24. A gap or chamber 26 is formed between the first ply 212 and the second ply 218. The chamber 26 can be filled with a selected atmosphere, such as, air, or a non-reactive gas such as, argon or krypton gas.

A hydrophobic coating 220 is positioned over at least a portion of the No. 1 surface 214 of the first ply 212 (FIGS. 8A and 8B). The hydrophobic coating 220 may be any of the hydrophobic coatings described herein.

A patterned conductive coating 230 may be positioned over at least a portion of the No. 2 surface 216 of the first ply 212 (FIG. 8A). Alternatively, a patterned conductive coating 230 may be positioned over at least a portion of the No. 3 surface 220 of the second ply 218 (FIG. 8B). When the insulating glass unit 200 includes two plies 212, 218, the patterned conductive coating 230 is not over at least a portion of No. 1 surface 214 of the first ply 212 or over at least a portion of No. 4 surface 222 of the second ply 218. The patterned conductive coating 230 may comprise, consist essentially of, or consist of any of the patterned conductive coatings described herein.

When the insulating glass unit 200 includes three plies, the patterned conductive coating 230 may be positioned over at least a portion of the No. 2 surface 216 of the first ply 212 (not shown), over at least a portion of the No. 3 surface 220 of the second ply 218 (not shown), over at least a portion of the No. 4 surface 222 of the second ply 218 (not shown), or over at least a portion of the No. 5 surface of the third ply (not shown). When the insulating glass unit 200 includes three plies, the patterned conductive coating 230 is not over at least a portion of the No. 1 surface of first ply 212 or over at least a portion of the No. 6 surface of third ply. The patterned conductive coating 230 may comprise, consist essentially of, or consist of any of the patterned conductive coatings described herein.

The hydrophobic coating 20 may be applied to the No. 1 surface 214 of the first ply 212 after the insulating glass unit 200 is assembled. Alternatively, the hydrophobic coating 20 may be applied to the No. 1 surface 214 of the first ply after the insulating glass unit 200 is installed in a building.

This disclosure is further described in the following numbered clauses:
Clause 1: An article comprising: a glass substrate having a No. 1 surface and a No. 2 surface opposite the No. 1 surface; a hydrophobic coating over at least a portion of the No. 1 surface; and a patterned conductive coating over at least a portion of the No. 2 surface.
Clause 2: The article of clause 1, wherein the hydrophobic coating is applied to the No. 1 surfacing using an MSVD coating process.
Clause 3: The article of clause 1, wherein the hydrophobic coating comprises one or more metal oxides.
Clause 4: The article of clause 1, wherein the hydrophobic coating comprises titanium, hafnium, silicon, aluminum, or cerium.
Clause 5: The article of clause 1, wherein the hydrophobic coating comprises a fluorinated organic material.
Clause 6: The article of any one of clauses 1 to 5, wherein the patterned conductive coating comprises a thickness of 2 nm to 200 nm.
Clause 7: The article of any one of clauses 1 to 6, wherein the patterned conductive coating comprises silver.
Clause 8: The article of any one of clauses 1 to 7, wherein the patterned conductive coating comprises a dielectric layer and a reflective layer.
Clause 9: The article of any one of clauses 1 to 8, wherein the glass substrate is a soda-lime glass.
Clause 10: The article of any one of clauses 1 to 9, wherein the article is an architectural structure.
Clause 11: The article of any one of clauses 1 to 10, wherein the article is a window.
Clause 12: An article comprising: a first glass substrate having a No. 1 surface and a No. 2 surface opposite the No. 1 surface; a second glass substrate opposite the first glass substrate having a No. 3 surface and a No. 4 surface opposite the No. 3 surface; a hydrophobic coating over at least a portion of the No. 1 surface; and a patterned conductive coating over at least a portion of the No. 2 surface or the No. 3 surface.
Clause 13: The article of clause 12, wherein the hydrophobic coating is applied to the No. 1 surfacing using an MSVD coating process.
Clause 14: The article of clause 12, wherein the hydrophobic coating comprises one or more metal oxides.
Clause 15: The article of clause 12, wherein the hydrophobic coating comprises titanium, hafnium, silicon, aluminum, or cerium.
Clause 16: The article of clause 12, wherein the hydrophobic coating comprises a fluorinated organic material.
Clause 17: The article of any one of clauses 12 to 16, wherein the patterned conductive coating comprises a dielectric layer and a reflective layer.
Clause 18: The article of any one of clauses 12 to 17, wherein the patterned conductive coating comprises silver.
Clause 19: The article of any one of clauses 12 to 18, wherein the patterned conductive coating comprises a thickness of 2 nm to 200 nm.
Clause 20: The article of any one of clauses 12 to 20, wherein the first glass substrate is a soda-lime glass.
Clause 21: The article of any one of clauses 12 to 20, wherein the first glass substrate and the second glass substrate are bonded to a spacer.
Clause 22: The article of any one of clauses 12 to 21, wherein the article is an architectural structure.
Clause 23: The article of clause 12, wherein the hydrophobic coating is applied to the No. 1 surfacing using a CVD coating process.
Clause 24: The article of clause 23, wherein the hydrophobic coating comprises one or more metal oxides.
Clause 25: The article of clause 23, wherein the hydrophobic coating comprises titanium, hafnium, silicon, aluminum, or cerium.
Clause 26: The article of any one of clauses 23 to 25, wherein the patterned conductive coating comprises a thickness of 2 nm to 200 nm.
Clause 27: The article of any one of clauses 23 to 26, wherein the patterned conductive coating comprises silver.
Clause 28: The article of any one of clauses 23 to 27, wherein the patterned conductive coating comprises a dielectric layer and a reflective layer.
Clause 29: The article of any one of clauses 23 to 28, wherein the glass substrate is a soda-lime glass.
Clause 30: The article of any one of clauses 23 to 29, wherein the article is an architectural structure.
Clause 31: The article of any one of clauses 23 to 31, wherein the article is a window.

### PROPHETIC EXAMPLES

### Prophetic Example 1

A glass substrate 12 having a No. 1 surface 14 and a No. 2 surface 16 opposite the No. 1 surface 14 will be obtained. The glass substrate has a conductive coating on the No. 2 surface 16. The conductive coating will be applied using MSVD. Portions of the conductive coating will be removed from the No. 2 surface 16 of the glass substrate using laser ablation to form the patterned conductive coating 30. The glass substrate 12 with the patterned conductive coating 30 on the No. 2 surface 16 will be tempered. After tempering, a hydrophobic coating 20 will be applied over the No. 1 surface 14.

### Prophetic Example 2

A glass substrate 12 having a No. 1 surface 14 and a No. 2 surface 16 opposite the No. 1 surface 14 will be obtained. A mask having a plurality of masked regions and a plurality of un-masked regions will be positioned over the No. 2 surface 16 of the glass substrate 12. The plurality of masked regions and the plurality of un-masked regions of the mask will be arranged in suitable manner to form a desired pattern. The conductive coating will be applied through the plurality of un-masked portions of the mask and onto the No. 2 surface 16 to form the patterned conductive coating 30. The conductive coating will be applied through the un-masked regions of the mask using MSVD. The glass substrate 12 with the patterned conductive coating 30 on the No. 2 surface 16 will be tempered. After tempering, a hydrophobic coating 20 will be applied over the No. 1 surface 14.

### Prophetic Example 3

A first ply 212 having a No. 1 surface 214 and a No. 2 surface 216 opposite the No. 1 surface 214 will be obtained. A second ply 218 having a No. 3 surface 220 and a No. 4 surface 222 opposite the No. 3 surface will be obtained. The first ply has a conductive coating on the No. 2 surface 216. Portions of the conductive coating will be removed from the No. 2 surface 216 using laser ablation to form the patterned conductive coating 230. The first ply 212 with the patterned conductive coating 230 on the No. 2 surface 216 will be tempered. After tempering, a hydrophobic coating 220 will be applied over the No. 1 surface 214.

The first ply 212 and the second ply 218 will be connected together to form an insulating glass unit 200. The No. 2 surface 216 of the first ply 212 will face the No. 3 surface 220 of the second ply 218. The first ply 212 and the second ply 218 will be connected together using a spacer frame 24 and a chamber filled with air will be formed between the first 212 and the second ply 218.

### Prophetic Example 4

A first ply 212 having a No. 1 surface 214 and a No. 2 surface 216 opposite the No. 1 surface 214 will be obtained. A second ply 218 having a No. 3 surface 220 and a No. 4 surface 222 opposite the No. 3 surface will be obtained. The second ply has a conductive coating on the No. 3 surface 220. Portions of the conductive coating will be removed from the No. 3 surface 220 using laser ablation to form the patterned conductive coating 230. The second ply 218 with the patterned conductive coating 230 on the No. 3 surface 220 will be tempered. A hydrophobic coating 220 will be applied over the No. 1 surface 214 of the first ply 212.

The first ply 212 and the second ply 218 will be connected together to form an insulating glass unit 200. The No. 2 surface 216 of the first ply 212 will face the No. 3 surface 220 of the second ply 218. The first ply 212 and the second ply 218 will be connected together using a spacer frame 24 and a chamber filled with air will be formed between the first 212 and the second ply 218.

### Prophetic Example 5

A first ply 212 having a No. 1 surface 214 and a No. 2 surface 216 opposite the No. 1 surface 214 will be obtained. A second ply 218 having a No. 3 surface 220 and a No. 4 surface 222 opposite the No. 3 surface will be obtained. A mask having a plurality of masked regions and a plurality of un-masked regions will be positioned over the No. 2 surface 216 of the first ply 212. The plurality of masked regions and the plurality of un-masked regions of the mask will be arranged in suitable manner to form a desired pattern. The conductive coating will be applied through the plurality of un-masked portions of the mask and onto the No. 2 surface 216 to form the patterned conductive coating 230. The conductive coating will be applied through the un-masked regions of the mask using MSVD. The first ply 212 with the patterned conductive coating 230 on the No. 2 surface 216 will be tempered. After tempering, a hydrophobic coating 220 will be applied over the No. 1 surface 214.

The first ply 212 and the second ply 218 will be connected together to form an insulating glass unit 200. The No. 2 surface 216 of the first ply 212 will face the No. 3 surface 220 of the second ply 218. The first ply 212 and the second ply 218 will be connected together using a spacer frame 24 and a chamber filled with air will be formed between the first 212 and the second ply 218.

### Prophetic Example 6

A first ply 212 having a No. 1 surface 214 and a No. 2 surface 216 opposite the No. 1 surface 214 will be obtained. A second ply 218 having a No. 3 surface 220 and a No. 4 surface 222 opposite the No. 3 surface will be obtained. A mask having a plurality of masked regions and a plurality of un-masked regions will be positioned over the No. 3 surface 220 of the second ply 218. The plurality of masked regions and the plurality of un-masked regions of the mask will be arranged in suitable manner to form a desired pattern. The conductive coating will be applied through the plurality of un-masked portions of the mask and onto the No. 3 surface 220 to form the patterned conductive coating 230. The conductive coating will be applied through the un-masked regions of the mask using MSVD. The second ply 218 with the patterned conductive coating 230 on the No. 3 surface 220 will be tempered. A hydrophobic coating 220 will be applied over the No. 1 surface 214 of the first ply 212.

The first ply 212 and the second ply 218 will be connected together to form an insulating glass unit 200. The No. 2 surface 216 of the first ply 212 will face the No. 3 surface 220 of the second ply 218. The first ply 212 and the second ply 218 will be connected together using a spacer frame 24 and a chamber filled with air will be formed between the first 212 and the second ply 218.

It will be readily appreciated by those skilled in the art that modifications may be made to the disclosure without departing from the concepts disclosed in the foregoing description. Accordingly, the particular examples described in detail herein are illustrative only and are not limiting to the scope of the disclosure, which is to be given the full breadth of the appended claims and any and all equivalents thereof.

What is claimed is:

1. An article comprising:
a glass substrate having a No. 1 surface and a No. 2 surface opposite the No. 1 surface;
a hydrophobic coating over at least a portion of the No. 1 surface; and
a patterned conductive coating over at least a portion of the No. 2 surface.

2. The article of claim 1, wherein the hydrophobic coating comprises one or more metal oxides.

3. The article of claim 1, wherein the hydrophobic coating comprises titanium, hafnium, silicon, aluminum, or cerium.

4. The article of claim 1, wherein the hydrophobic coating comprises a fluorinated organic material.

5. The article of claim 1, wherein the patterned conductive coating comprises a thickness of 2 nm to 200 nm.

6. The article of claim 1, wherein the patterned conductive coating comprises silver.

7. The article of claim 1, wherein the patterned conductive coating comprises a dielectric layer and a reflective layer.

8. The article of claim 1, wherein the article is an architectural structure.

9. The article of claim 1, wherein the article is a window.

10. An article comprising:
a first glass substrate having a No. 1 surface and a No. 2 surface opposite the No. 1 surface;
a second glass substrate opposite the first glass substrate having a No. 3 surface and a No. 4 surface opposite the No. 3 surface;
a hydrophobic coating over at least a portion of the No. 1 surface; and
a patterned conductive coating over at least a portion of the No. 2 surface or the No. 3 surface.

11. The article of claim 10, wherein the hydrophobic coating comprises one or more metal oxides.

12. The article of claim 10, wherein the hydrophobic coating comprises titanium, hafnium, silicon, aluminum, or cerium.

13. The article of claim 10, wherein the hydrophobic coating comprises a fluorinated organic material.

14. The article of claim 10, wherein the patterned conductive coating comprises a dielectric layer and a reflective layer.

15. The article of claim 10, wherein the patterned conductive coating comprises silver.

16. The article of claim 10, wherein the patterned conductive coating comprises a thickness of 2 nm to 200 nm.

17. The article of claim 10, wherein the first glass substrate and the second glass substrate are bonded to a spacer.

18. The article of claim 10, wherein the article is an architectural structure.

19. The article of claim 10, wherein the article is a window.
